(19) United States
(12) Patent Application Publication
(10) Pub. No.: US 2010/0186236 A1
(43) Pub. Date: Jul. 29, 2010

(54) BEVERAGE UTENSIL

(76) Inventor: Dora J. Topolinski, Jenison, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/359,600

(22) Filed: Jan. 26, 2009

(51) Int. Cl. A47J 43/28; A47G 19/22

(52) U.S. Cl. 30/123; 30/327; 220/703

(57) ABSTRACT

A beverage utensil for enhancing the enjoyment of a multiple phase beverage includes a bowl portion and a handle portion extending upwardly away from a section of a rim of the bowl portion. The beverage utensil may be used in combination with a beverage container having a diameter only slightly larger than the diameter of the bowl portion of the utensil to facilitate collection and consumption of non-liquid materials of a multiple phase beverage.

### FIELD OF THE INVENTION

This invention relates to the field of food and beverage utensils and more particularly to utensils used for separating foams, solids, semi-solids and other non-liquid or partially liquid materials from a multiple phase beverage for consumption separate from a liquid phase of the beverage.

### BACKGROUND OF THE INVENTION

Beverages are typically served from open containers, such as glassware, cups, mugs, bottles, cans, tumblers and the like, that allow the beverage to be poured over a lip or rim of the container and into the mouth of a consumer. Beverages are sometimes served from containers having a straw, either loosely disposed in the beverage, or affixed to a lid on the beverage container. In the case of beverages having a thick consistency, a high viscosity, and/or containing solids, semi-solids, foam or other spoonable materials that are not comprised of only liquid, it is common to serve and consume the beverage with a spoon. Examples of such beverages that may be better enjoyed with a spoon include beverages containing ice cream or made of ice cream, such as milk shakes, sippable sundaes; foamy drinks, such as cappuccinos; thick drinks containing suspended solids, such as pieces of candy; and crushed ice beverages. There are numerous patents describing and claiming utensils that incorporate both spoon and straw functionalities into a single device. These utensils generally comprise a handle portion defining a conduit that extends along substantially the entire length of the handle portion and which is open at each end, and a bowl or scoop portion integral with the distal end of the handle portion. The bowl or scoop allows a person using the utensil to scoop up solid, semi-solid, foam or other material (including liquids) and deposit the material in the user's mouth, while the conduit allows the person using the utensil to draw fluids (e.g., liquid) from a beverage container into the user's mouth.

While the combination spoon and straw utensil has undoubtedly provided enhanced enjoyment of beverages containing or consisting of solids, semi-solids, foams, highly viscous fluids or other materials that are spoonable or scoopable, there remains a need for improved beverage utensils that further raise the enjoyment level for consumers of thick, frothy, foamy, creamy and/or other beverages comprising non-liquid components.

### SUMMARY OF THE INVENTION

The invention provides a utensil that enables enhanced enjoyment of beverages containing spoonable and/or scoopable non-liquid materials such as solids, semi-solids, foams, viscous or gooey syrup-like materials, and other materials that constitute a phase separate from the liquid phase of the beverage.

In accordance with certain aspects of the invention, there is provided a utensil for collecting and extracting non-liquid material from a beverage held in a beverage container, wherein the utensil includes a bowl portion and an elongate handle portion extending upwardly away from a section of a rim of the bowl portion.

In certain other aspects of the invention there is provided a combination beverage container and utensil for collecting and extracting non-liquid material from a beverage held in a beverage container, wherein the combination includes a frustoconical or cylindrical container, and a utensil having a bowl portion and an elongate handle portion extending upwardly away from a section of a rim of the bowl portion.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a front perspective view of a utensil for collecting and extracting non-liquid material from a beverage held in a beverage container.

FIG. 2 is a side perspective view of the utensil shown in FIG. 1.

FIG. 3 is a front perspective view of the utensil shown in FIG. 1 positioned in a transparent beverage container.

FIG. 4 is a front perspective view of the utensil and beverage container of FIG. 3, with an end of the handle portion of the utensil folded over to allow a lid to be positioned on the rim of the beverage container.

FIG. 5 is a front perspective view of the beverage container and utensil with folded handle portion shown in FIG. 4 with a beverage having non-liquid phase material suspended therein deposited in the beverage container.

FIG. 6 is a front perspective view of the utensil and beverage container of FIG. 5 in which the beverage has been consumed and wherein the suspended non-liquid materials have been collected on a bowl portion of the utensil.

FIG. 7 is a perspective view of the utensil shown in FIG. 6 with non-liquid materials on the bowl portion of the utensil being poured or otherwise introduced to the mouth of a person consuming the beverage.

### DETAILED DESCRIPTION OF PREFERRED EMBODIMENTS

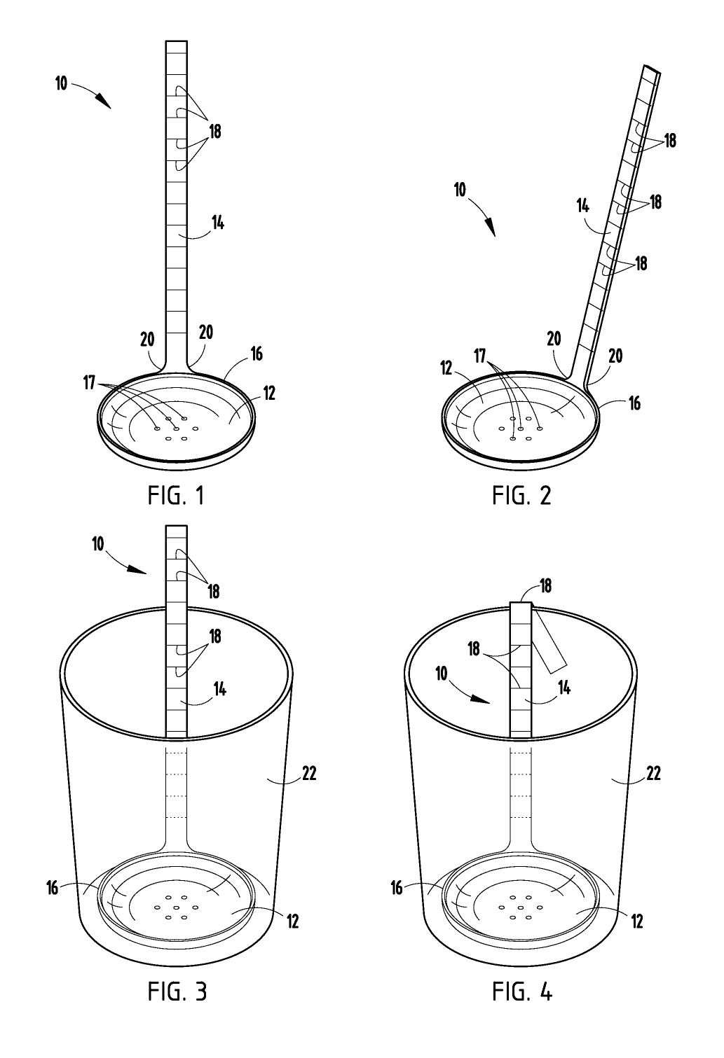

In accordance with certain embodiments of the invention, a utensil 10 for collecting and extracting non-liquid material from a beverage held in a beverage container includes a bowl portion 12 and a handle portion 14, as shown in FIGS. 1 and 2. The bowl portion preferably has a spheroidal cap shell structure.

The term “spheroidal” refers to a shape or structure that is not necessarily perfectly spherical, but may be ellipsoidal or some other shape that deviates slightly from the shape of a sphere. The term “spheroidal cap” refers to a region or portion of a sphere or spheroid which lies above a plane cutting through the sphere (i.e., the bowl portion 12 has a shape generally conforming to the shape of a section of a sphere or spheroid). The expression “spheroidal cap” is also meant to encompass spheroidal sections defined by a region between two planes (typically parallel planes) passing through a sphere or spheroid. The expression “shell” refers to the fact that a bowl is typically defined by a material located between two surfaces, an inner surface of the bowl and an outer surface of the bowl.

Unlike most spoons, in which the handle portion extends laterally or horizontally away from the bowl when the bowl opening is facing upwardly, the utensil of this invention has an elongate handle portion 14 that extends upwardly away from a section of the rim 16 of the bowl portion when the bowl portion is arranged with the opening facing upwardly (with the rim of the bowl in a horizontal plane). However, it should be understood that the expression “upwardly away from a section of a rim of the bowl portion” also encompasses small angles (typically less than 10 degrees) from vertical, such as the angle that the walls of a container, such as a disposable beverage container, would have with a vertical surface upon which the beverage container is supported.

Preferably, bowl portion 14 has a spherical cap shell structure, and the rim 16 of bowl portion 14 defines a circle.

In certain preferred embodiments, the bowl portion may include one or more openings 17, typically near the center or bottom of the bowl, to allow liquid to drain from the bowl portion as it is removed from a beverage, while non-liquid material is retained on the bowl portion.

The expression “non-liquid material” is meant to generally refer to any material that exists in a different phase from the main liquid component of a multiple phase beverage. More specifically, non-liquid materials include, for example, solids (e.g., cookie pieces, candy pieces, etc.), gooey materials that exist in a phase that is distinct from the main liquid phase of the beverage (e.g., syrup-like materials), foams (which are a combination of air and liquid, such as a foam, cream or milk), crushed ice, semi-solids and the like.

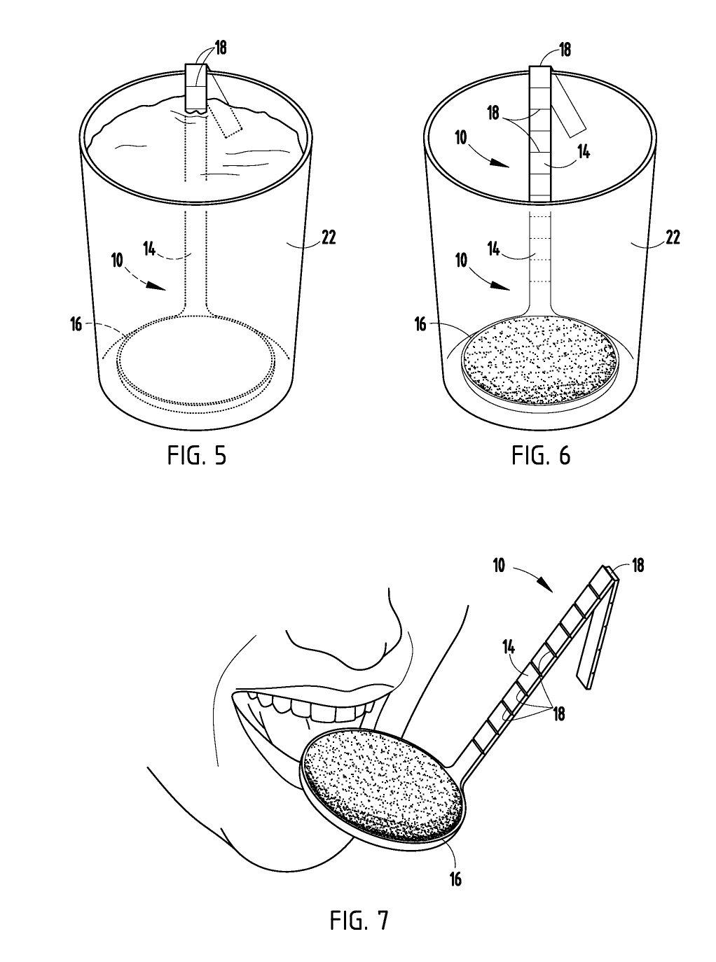

The utensils of this invention may be configured for use with a particular beverage container 22, as shown in FIGS. 3-6, or they may be configured for use with any of a variety of different sized containers. In such case, it is desirable that the handle portion is provided with a plurality of scores 18 that allow handle portion 12 to be easily folded so that the utensil can be supported on the rim of a beverage container with the bowl portion 12 of utensil 10 being suspended above a bottom of a beverage container or on a bottom of a beverage container, while allowing a lid to be fitted on the rim of the beverage container over the folded section of the handle portion, as shown in FIGS. 4-6.

Utensil 10 preferably includes gussets 20 (FIG. 1) at the end of handle portion 14 that is connected with bowl portion 12 in order to strengthen the connection between the handle portion and bowl portion.

In accordance with certain aspects of the invention, a combination beverage container and utensil for collecting and extracting non-liquid material from a beverage held in a beverage container is provided. The combination includes a frustoconical or cylindrical container 22 and a utensil 10 having a bowl portion 12 and an elongated handle portion 14 that extends upwardly away from a section of a rim 16 of bowl portion 12, with handle portion 14 being bent to allow it to be supported on rim 16 of beverage container 22. Desirably, bowl portion 12 has a diameter that is only slightly less than the minimum diameter of beverage container 22. This allows a very substantial portion of the non-liquid materials in a beverage to be collected on bowl portion 12 if desired during consumption of a beverage. For example, bowl portion 12 will typically have a diameter that is at least about 90 percent of the minimum diameter of container 22.

As shown in FIG. 6, as the liquid portion of a beverage is consumed, solid material can be collected in the bowl 12 of utensil 10, and subsequently transferred from the bowl to a mouth 28 of a person consuming the beverage, as shown in FIG. 7.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A utensil for collecting and extracting non-liquid material from a beverage held in a beverage container, comprising:
a bowl portion having a spheroidal cap shell structure, the bowl portion including at least one opening to allow liquid to drain from the bowl portion as it is removed from the beverage, while retaining non-liquid material on the bowl portion; and
an elongate handle portion extending upwardly away from a section of a rim of the bowl portion at an angle less than 10 degrees from vertical when the bowl portion is arranged with the rim in a horizontal plane.

2. The utensil of claim 1, wherein the bowl portion has a spherical cap shell structure, wherein the rim of the bowl portion defines a circle.

3. (canceled)

4. The utensil of claim 1, wherein the handle portion includes a plurality of scores that allow the handle portion to be folded so that the utensil can be supported on a rim of a beverage container with the bowl portion suspended above or supported on a bottom of the beverage container, while allowing a lid to be fitted on the rim of the beverage container.

5. The utensil of claim 1, which is made of a thermoplastic material.

6. The utensil of claim 1, in which the handle portion includes gussets at an end of the handle portion to strengthen connection between the handle portion and the bowl portion.

7. A combination for collecting and extracting non-liquid material from a beverage container, comprising:
a container; and
a utensil having a bowl portion and an elongate handle portion extending upwardly away from a rim of the bowl portion at an angle less than 10 degrees from vertical when the bowl portion is arranged with the rim in a horizontal plane, the bowl portion including at least one opening to allow liquid to drain from the bowl portion as it is removed from the beverage, while retaining non-liquid material on the bowl portion, the handle portion being bent to allow the utensil to be supported on a rim of the container with the bowl portion suspended above or supported on a bottom of the container, while allowing a lid to be fitted on the rim of the beverage container.

8. The combination of claim 7, wherein the bowl portion has a diameter that is only slightly less than a minimum diameter of the beverage container.

9. The combination of claim 7, wherein the bowl portion has a diameter that is at least 90 percent of a minimum diameter of the beverage container.

10. The combination of claim 7, wherein the bowl portion has a spheroidal cap shell structure.

11. The combination of claim 7, wherein the bowl portion has a spherical cap shell structure.

12. (canceled)

13. (canceled)

14. The combination of claim 7, wherein the utensil is made of a thermoplastic material.

15. The combination of claim 7, wherein the handle portion of the utensil includes gussets at an end of the handle portion to strengthen a connection between the handle portion and the bowl portion of the utensil.

16. A combination for collecting and extracting non-liquid material from a beverage, comprising:
a container; and
a utensil including a bowl portion having a spheroidal cap shell structure and an elongate handle portion extending upwardly away from a section of a rim of the bowl portion at an angle less than 10 degrees from vertical when the bowl portion is arranged with the rim in a horizontal plane, the bowl portion including at least one opening to allow liquid to drain from the bowl portion as it is removed from a beverage, while retaining non-liquid material on the bowl portion, the handle portion being bent to allow the utensil to be supported on a rim of the container with the bowl portion suspended above or supported on a bottom of the container, while allowing a lid to be fitted on the rim of the container.
